(19) United States
(12) Patent Application Publication
(10) Pub. No.: US 2016/0373988 A1
(43) Pub. Date: Dec. 22, 2016

(54) BASE STATION AND METHOD FOR CONTROLLING WIRELESS COMMUNICATION

(71) Applicant: FUJITSU LIMITED, Kawasaki-shi (JP)

(72) Inventor: Nobukazu FUDABA, Yokohama (JP)

(21) Appl. No.: 15/180,923

(22) Filed: Jun. 13, 2016

(30) Foreign Application Priority Data
Jun. 16, 2015 (JP) 2015-121536

(51) Int. Cl. H04W 36/22

(52) U.S. Cl. CPC H04W 36/22

(57) ABSTRACT

A base station including: a processor configured to: form a plurality of cells, each of the plurality of cells having each of a plurality of different frequency bands, obtain capability information and state information when a number of a plurality of terminals coupling to a specified cell of the plurality of cells exceeds a predetermined threshold, the capability information indicating each capability of each of the plurality of terminals for coupling to a different cell of the plurality of cells, the state information indicating each state of each coupling between each of the plurality of terminals and the different cell, select a first terminal from among the plurality of terminals based on the first information and the second information, a coupling between the first terminal and the specified cell being to be released, and switch a cell coupled by the first terminal, from the specified cell to the different cell.

### CROSS-REFERENCE TO RELATED APPLICATION

This application is based upon and claims the benefit of priority of the prior Japanese Patent Application No. 2015-121536, filed on Jun. 16, 2015, the entire contents of which are incorporated herein by reference.

### FIELD

The embodiments discussed herein are related to a base station and a method for controlling a wireless communication.

### BACKGROUND

In recent years, there has been known a base station device that has a multi-carrier function and that simultaneously manages multiple cells having different frequency bands and communicates with the multiple cells or terminals connected (or coupled) to the multiple cells.

In the base station device having the multi-carrier function, when multiple terminals temporarily concentrate into a specific cell among the multiple cells, the number of terminals connected to the specific cell may exceed a predetermined threshold. In this case, it is difficult for the terminals connected to the specific cell to maintain communication with the base station device. For example, when the exceeded terminal wishing to connect to the specific cell poses an interference problem by starting to connect to the other base station devices, the communication becomes difficult.

For solving this problem, for example, when the number of terminals connected to the specific cell exceeds the predetermined threshold, it may be considered to perform load balance control to change a connection destination (or connecting destination) of the terminal from the specific cell to another cell having a less number of terminals among the multiple cells.

However, some of the terminals have no connection capability (or coupling capability) to the other cell or are poor in the connection state (or coupling state) with the other cell. Thus, it may become difficult to change the connection destination of such terminals to the other cell, and therefore the problem of the excessive number of users may not be solved by the load balance control only.

As a conventional technique, the following technique is disclosed by Japanese Laid-open Patent Publication Nos. 11-136729 and 2014-236504 for solving the problem of the excessive number of terminals in the specific cell by methods other than the load balance control mentioned above. As an exemplary conventional technique applied to a base station device managing one cell, there is a technique of a handover of a terminal connected to the cell of the base station device to an adjacent cell managed by another base station device while reducing transmission power of the cell of the base station device.

### SUMMARY

According to an aspect of the invention, a base station includes a memory, and a processor coupled to the memory and configured to: form a plurality of cells, each of the plurality of cells having each of a plurality of different frequency bands, obtain capability information and state information when a number of a plurality of terminals coupling to a specified cell of the plurality of cells exceeds a predetermined threshold, the capability information indicating each capability of each of the plurality of terminals for coupling to a different cell of the plurality of cells, the state information indicating each state of each coupling between each of the plurality of terminals and the different cell, select a first terminal from among the plurality of terminals based on the first information and the second information, a coupling between the first terminal and the specified cell being to be released, and switch a cell coupled by the first terminal, from the specified cell to the different cell.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a radio communication system including a base station device according to the embodiment;

FIG. 2 is a diagram for illustrating a premise technique for solving a problem of the excessive number of terminals in a specific cell;

FIG. 3 is a block diagram of the base station device according to the embodiment;

FIG. 4 is a diagram for illustrating selection of a first type terminal, a second type terminal or a third type terminal by a candidate terminal selection unit according to the embodiment;

FIG. 5 is a diagram for illustrating an example of changing the connection destination of the first candidate terminal when the first candidate terminal is the first type terminal;

FIG. 6 is a diagram for illustrating an example of changing the connection destination of the first candidate terminal when the first candidate terminal is the second type terminal;

FIG. 7 is a diagram for illustrating an example of changing the connection destination of the first candidate terminal when the first candidate terminal is the third type terminal;

FIG. 8 is a diagram for illustrating an example of changing the connection destination of the second candidate terminal;

FIG. 9 is a diagram illustrating an example of an internal table used by the candidate terminal selection unit;

FIG. 10 is a flowchart of a process of changing the connection destination of a terminal by the base station device according to the embodiment;

FIG. 11 is a flowchart of an in-cell connection destination changing processing according to the embodiment;

FIG. 12 is a diagram for illustrating an example of generating a candidate terminal list;

FIG. 13 is a flowchart of an out-cell connection destination changing processing according to the embodiment; and

FIG. 14 is a diagram illustrating a hardware configuration example of the base station device.

### DESCRIPTION OF EMBODIMENTS

However, in a case where the base station device is the base station device having the multi-carrier function, the conventional technique performs handover of the terminal in the specific cell having the number of terminals exceeding the threshold to the adjacent cell and reduces the transmission power of the specific cell. For this reason, even when the number of terminals connected to the other cell among the multiple cells in the base station device is not larger than the threshold, the conventional technique performs handover from the specific cell to the adjacent cell and reduces the transmission power. As a result, there is a possibility that the conventional technique deteriorates the signal quality in the specific cell.

In view of the foregoing problems, it is an object of the present disclosure to provide a base station device and a base station device control method capable of suppressing deterioration of the signal quality in the cell of the base station.

Hereinafter, an embodiment of the base station device and the base station device control method according to the present disclosure is described in detail with reference to the accompanying drawings. Note that the disclosed technique is not limited by the embodiment.

### EMBODIMENT

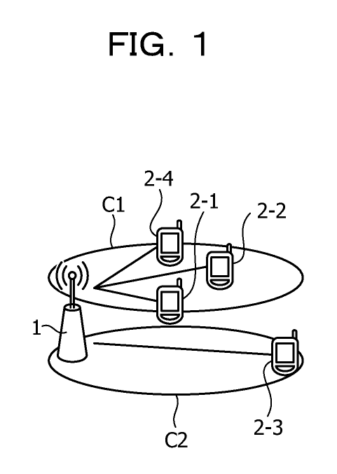

FIG. 1 is a configuration diagram of a radio communication system including a base station device according to the embodiment. As illustrated in FIG. 1, the radio communication system according to the embodiment includes a base station device 1 and terminals 2-1 to 2-4.

The base station device 1 includes a multi-carrier function. Specifically, the base station device 1 communicates with multiple cells having different frequency bands or the terminals 2-1 to 2-4 respectively connected to the multiple cells. In the example of FIG. 1, the base station device 1 communicates with the terminals 2-1, 2-2, and 2-4 connected to a cell C1. Also, the base station device 1 communicates with the terminal 2-3 connected to a cell C2. FIG. 1 illustrates an example of the base station device 1 managing the two cells having different frequency bands. However, the number of cells managed by the base station device 1 may be three or more.

The terminals 2-1 to 2-4 transmit and receive data from the base station device 1 by using a radio resource of the cell C1 or C2.

Here, the number of terminals connectable to the cell C1 or C2 is limited by a predetermined threshold. When the number of the terminals connected to the cell C1 or C2 exceeds the predetermined value, it is difficult for the terminal connected to the cell C1 or C2 to maintain communication with the base station device 1. For example, when the exceeded terminal wishing to connect to the cell C1 or C2 poses an interference problem by start to connect to the other base station devices, it is difficult for the terminal to maintain communication with the base station device 1.

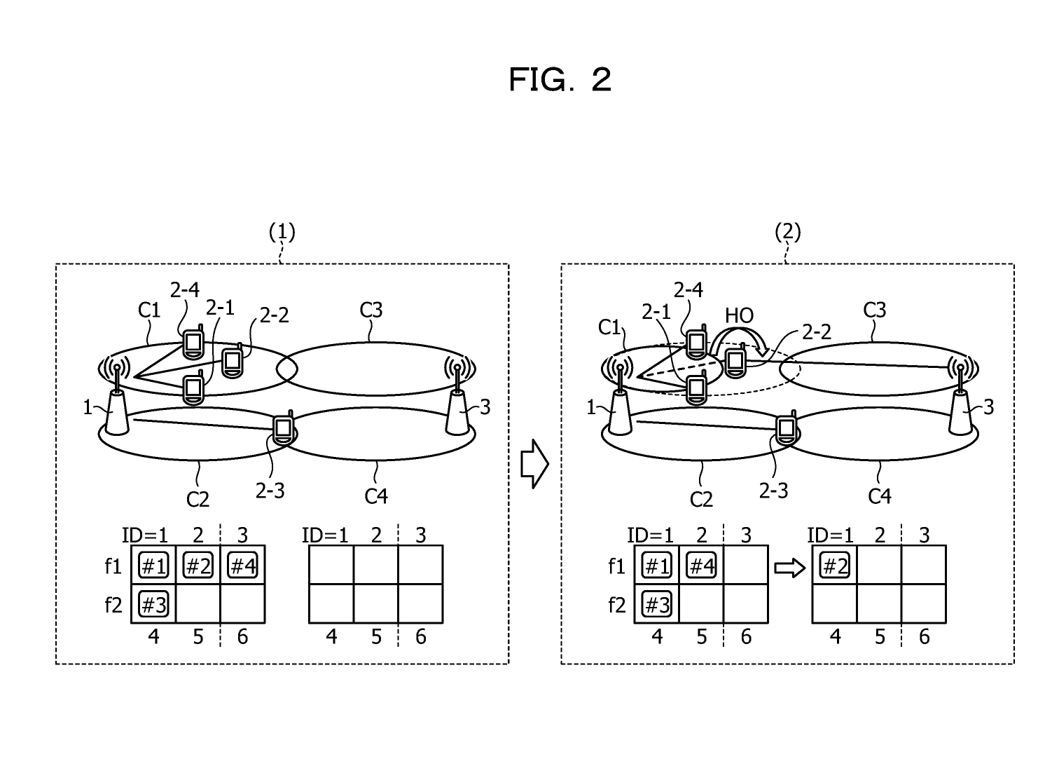

Next, before describing the base station device 1 according to the embodiment, a technique as a premise for the base station device 1 is described. FIG. 2 is a diagram for illustrating the premise technique for solving the problem of the excessive number of terminals in the specific cell.

In FIG. 2, both the base station device 1 and a base station device 3 are base station devices providing the multi-carrier function to the terminals by using two cells. The base station device 1 may communicate with up to two terminals in each of the cells C1 and C2, and the base station device 3 may communicate with up to two terminals in each of cells C3 and C4. That is, the connection number threshold indicating the number of the terminals connectable to each of the cells C1 to C4 is “2”. In FIG. 2, f1 indicates a frequency band common to the cells C1 and C3, and f2 indicates a frequency band common to the cells C2 and C4. In FIG. 2, ID is an identifier for identifying a terminal to which the radio resource is allocated when the base station device 1 or 3 performs scheduling processing, and three IDs are defined for each cell. In FIG. 2, each of #1 to #4 indicates the radio resource allocated respectively to the terminals 2-1 to 2-4 in each cell.

State (1) of FIG. 2 indicates a state in which the terminal 2-4 is newly connected to the cell C1 while the terminals 2-1 and 2-2 are connected to the cell C1 and the terminal 2-3 is connected to the cell C2. Since the number of the terminals connected to the cell C1 exceeds the connection number threshold “2”, the base station device 1 selects, out of the terminals 2-1, 2-2, and 2-4 connected to the cell C1, a handover candidate which is a terminal to be performed a handover to the cell C3 adjacent to the cell C1. For example, the base station device 1 selects, as the handover candidate, the terminal 2-2 which has the best reception quality in the adjacent cell C3.

Then, as illustrated in state (2) of FIG. 2, the base station device 1 performs a handover of the selected terminal 2-2 to the adjacent cell C3 and reduces the transmission power of the cell C1. As the transmission power of the cell C1 is reduced, coverage of the cell C1 shrinks.

Here, problems of the premise technique are described. The terminal 2-3 located in a boundary between the cell C2 and the cell C4 adjacent to the cell C2 is considered to be suitable for the handover candidate since the terminal has higher reception quality for the base station 3 than the terminal 2-2 located close to the center of the cell C1. However, in the premise technique, the base station device 1 selects a terminal connected to the cell C1 having the excessive number of the terminals as the handover candidate. Thus, the base station device 1 does not select the terminal 2-3 connected to the cell C2 as the handover candidate. For this reason, in the premise technique, even when the number of terminals connected to the cell C2 among the cells C1 and C2 managed in the base station device 1 is not larger than the connection number threshold “2”, the base station device 1 performs the handover to the adjacent cell and reduction of the transmission power in the cell C1. As a result, the premise technique deteriorates signal quality in the cell C1.

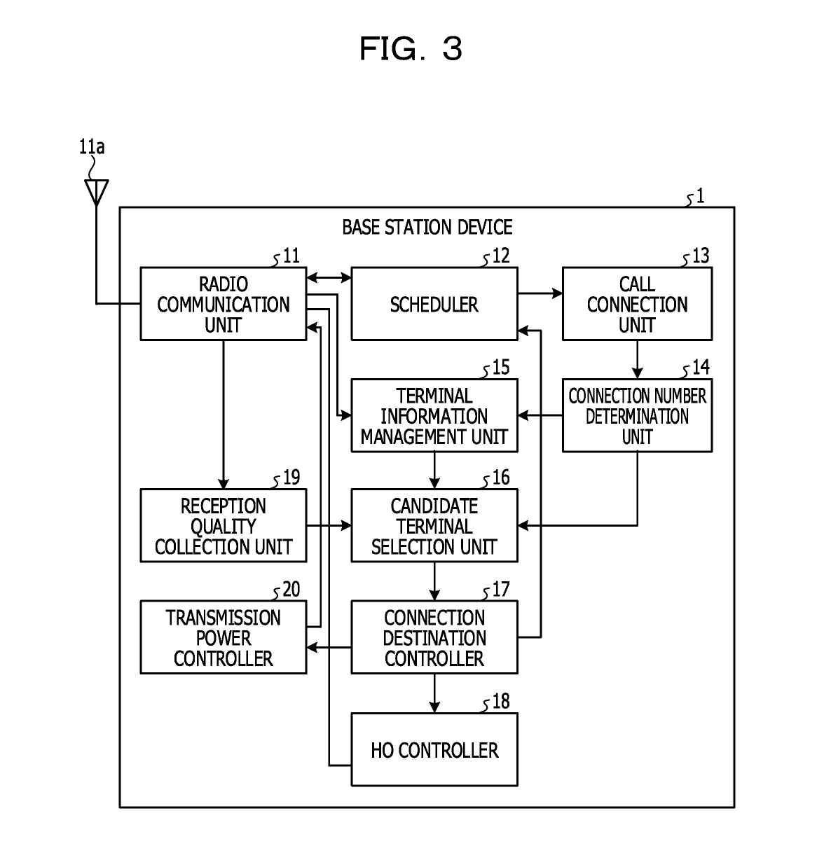

Next, configuration of the base station device 1 according to the embodiment is described with reference to FIG. 3. FIG. 3 is a block diagram of the base station device according to the embodiment. The base station device 1 illustrated in FIG. 3 includes a radio communication unit 11, a scheduler 12, a call connection unit 13, a connection number determination unit 14, a terminal information management unit 15, a candidate terminal selection unit 16, a connection destination controller 17, a handover (HO) controller 18, a reception quality collection unit 19, and a transmission power controller 20.

The radio communication unit 11 is configured to manage the multiple cells having different frequency bands and to communicate with the multiple cells managed therein or terminals connected to each of the multiple cells. For example, the radio communication unit 11 transmits/receives various signals and various data to/from the terminals connected to each of the cells C1 and C2 via an antenna 11a. Also, for example, the radio communication unit 11 sets the radio resource allocated by the scheduling processing to the terminal via the antenna 11a. The radio communication unit 11 corresponds to an example of “communication unit”.

The scheduler 12 performs the scheduling processing of allocating the radio resource of each of the multiple cells to the multiple cells or the terminals connected to each of the multiple cells. Specifically, the scheduler 12 manages the identifier (hereinafter referred to as a “radio resource ID”) for identifying the terminal to which the radio resource is allocated when performing the scheduling processing. Then, the scheduler 12 allocates the radio resource of each of the multiple cells to the terminal identified by the radio resource ID. The scheduler 12 outputs the radio resource allocated by the scheduling processing to the radio communication unit 11.

Also, upon receiving input of a connection request from an unconnected terminal via the radio communication unit 11, the scheduler 12 outputs the connection request to the call connection unit 13.

The call connection unit 13 receives input of the connection request from the scheduler 12. The call connection unit 13 connects the unconnected terminal to a cell designated by the connection request. Then, the call connection unit 13 detects the number of the terminals connected to each of the multiple cells managed by the radio communication unit and outputs the detected number of the terminals to the connection number determination unit 14.

The connection number determination unit 14 prestores the connection number threshold indicating the number of the terminals connectable to each of the multiple cells managed by the radio communication unit 11. The connection number determination unit 14 receives input of the number of the terminals connected to each of the multiple cells from the call connection unit 13. The connection number determination unit 14 determines whether the number of the terminals connected to each of the multiple cells exceeds the connection number threshold. The connection number determination unit 14 outputs the determination result to the terminal information management unit 15 and the candidate terminal selection unit 16.

The terminal information management unit 15 acquires terminal information indicating a connection capability and a connection state from the terminal connected to each of the multiple cells via the radio communication unit 11, and manages the acquired terminal information for each of the terminals. Here, the connection capability is a capability of connecting to each of the multiple cells managed by the radio communication unit 11 and communicating with the base station device 1 by using the radio resource of the connected cell. The connection state is a cell setting state used in the communication with each of the multiple cells managed by the radio communication unit 11 and the reception quality of the cell. The terminal information management unit 15 receives input of the determination result from the connection number determination unit 14. Using the determination result, the terminal information management unit 15 determines whether the number of the multiple terminals connected to one cell among the multiple cells managed by the radio communication unit 11 exceeds the connection number threshold.

When the number of the terminals connected to one cell among the multiple cells exceeds the connection number threshold, the terminal information management unit 15 performs the following processing. With reference to the terminal information, the terminal information management unit 15 acquires, for each of the terminals, terminal information indicating the connection capability to other cells (hereinafter referred to as “other cell”) excluding the one cell (hereinafter referred to as “exceeded cell”) in which the number of the multiple terminals exceeds the connection number threshold, and the state of connection to the other cell. The terminal information management unit 15 outputs the acquired terminal information to the candidate terminal selection unit 16. The terminal information management unit 15 corresponds to an example of a “collection unit”.

The candidate terminal selection unit 16 receives input of the terminal information from the terminal information management unit 15. Based on the connection capability and the connection state indicated by the terminal information, the candidate terminal selection unit 16 selects a first candidate terminal being a terminal to be released from the connection with the exceeded cell out of the multiple terminals connected to the exceeded cell, and outputs information of the selected first candidate terminal to the connection destination controller 17. The first candidate terminal is a first type terminal (a terminal of first type), a second type terminal (a terminal of second type) or a third type terminal (a terminal of third type).

The first type terminal is a terminal simultaneously connected to the other cell and the exceeded cell subordinate to the other cell, and includes a connection capability of communicating with the base station device 1 by using the radio resources of the exceeded cell and the other cell. For example, the first type terminal is simultaneously connected to the other cell being a primary cell (Pcell) and the exceeded cell being a secondary cell (Scell), and includes a carrier aggregation (CA) capability of communicating by using the radio resources of the Pcell and Scell.

The second type terminal is a terminal connected to either the exceeded cell or the other cell and includes the connection capability of communicating with the base station device 1 by using the radio resource of the connected cell. For example, the second type terminal is connected to either the exceeded cell or the other cell although connectable to both of the cells, and includes a multiband capability of communicating by using the radio resource of the connected cell.

The third type terminal is a terminal simultaneously connected to the exceeded cell and the other cell subordinate to the exceeded cell and includes the connection capability of communicating with the base station device 1 by using the radio resources of the exceeded cell and the other cell. For example, the third type terminal is simultaneously connected to the exceeded cell being the Pcell and the other cell being the Scell, and includes the CA capability of communicating by using the radio resources of the Pcell and Scell.

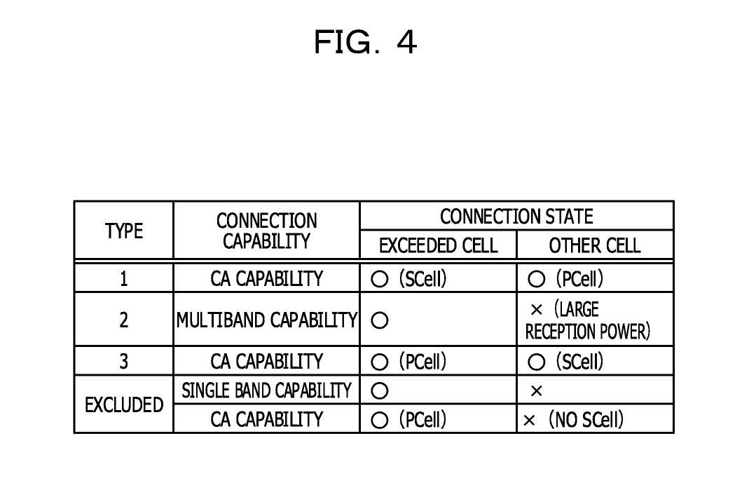

FIG. 4 is a diagram for illustrating selection of the first, second or third type terminal by the candidate terminal selection unit 16 according to the embodiment.

The candidate terminal selection unit 16 includes the connection capability to the other cell among the multiple terminals connected to the exceeded cell, and selects a terminal having a good connection state with the other cell as the first candidate terminal. Here, including the connection capability to the other cell means including the CA capability or the multiband capability. The good connection state with the other cell means that a case where the other cell is used as the Pcell or the Scell when the terminal includes the CA capability or a case where the Scell is not used even when the reception power is enough for using the other cell as the Scell. Moreover, the good connection state with the other cell means that the reception power in the other cell is higher than a predetermined value when the terminal includes the multiband capability. In the example of FIG. 4, the candidate terminal selection unit 16 selects the first type terminal which includes the CA capability and uses the other cell as the Pcell as the first candidate terminal. In another case, for example, the candidate terminal selection unit 16 selects the second type terminal which includes the multiband capability and whose reception power in the other cell is higher than a predetermined value as the first candidate terminal. Moreover, for example, the candidate terminal selection unit 16 selects the third type terminal which includes the CA capability and uses the other cell as the Scell as the first candidate terminal.

Among multiple terminals connected to the exceeded cell, the candidate terminal selection unit 16 excludes a terminal not including the connection capability to the other cell from the first candidate terminal. In the example of FIG. 4, the candidate terminal selection unit 16 excludes the terminal that is connected to the exceeded cell only and includes a single band capability of communicating by using the radio resource of the exceeded cell, from the first candidate terminal.

Further, among multiple terminals connected to the exceeded cell, the candidate terminal selection unit 16 excludes a terminal that includes a connection capability to the other cell and has a poor connection state with the other cell from the first candidate terminal. Here, the poor connection state with the other cell means that, when the terminal includes the CA capability, the reception power in the other cell is lower than a predetermined value and the other cell is not used as the Scell. In the example of FIG. 4, the candidate terminal selection unit 16 excludes a terminal including the CA capability and whose other cell is not used as the Scell from the first candidate terminal.

Description is continued by referring back to FIG. 3. The candidate terminal selection unit 16 receives input of the determination result from the connection number determination unit 14. After the connection destination of the first candidate terminal is changed to the other cell by the connection destination controller 17 described later, the candidate terminal selection unit 16 determines, by using the determination result, whether the number of the multiple terminals connected to the exceeded cell exceeds the connection number threshold. When the number of the multiple terminals connected to the exceeded cell exceeds the connection number threshold, the candidate terminal selection unit 16 performs the following processing. That is, the candidate terminal selection unit 16 receives, from the reception quality collection unit 19 described later, input of reception quality (hereinafter referred to as “adjacent cell reception quality”) of a terminal connected to each of multiple cells in a case where the terminal connected to each of the multiple cells connects to an adjacent cell which is the cell of another base station device adjacent to the multiple cells. Based on the adjacent cell reception quality, the candidate terminal selection unit 16 selects a second candidate terminal being a terminal to be released from the connection with the exceeded cell or the other cell out of the multiple terminals connected to the exceeded cell and out of the multiple terminals connected to the other cell, and outputs the selected second candidate terminal to the connection destination controller 17.

Here, a processing in which the candidate terminal selection unit 16 selects the second candidate terminal is described in detail. The candidate terminal selection unit 16 calculates the transmission power reduction amount such that an amount of the transmission power for communication of the radio communication unit 11 is more reduced as the adjacent cell reception quality becomes lower, of each of the multiple terminals connected to the exceeded cell or the other cell. Then, the candidate terminal selection unit 16 selects a terminal having the lowest transmission power reduction amount as the second candidate terminal out of the multiple terminals connected to the exceeded cell or the other cell. The candidate terminal selection unit 16 outputs the lowest transmission power reduction amount corresponding to the second candidate terminal to the connection destination controller 17. The candidate terminal selection unit 16 corresponds to an example of a “selection unit”.

The connection destination controller 17 receives input of the first candidate terminal or the second candidate terminal from the candidate terminal selection unit 16. Upon receiving input of the first candidate terminal, the connection destination controller 17 changes the connection destination of the first candidate terminal to the other cell. Meanwhile, upon receiving input of the second candidate terminal, the connection destination controller 17 changes the connection destination of the second candidate terminal to the adjacent cell. Hereinafter, details of changing the connection destination of the first candidate terminal and details of changing the connection destination of the second candidate terminal are described in this order.

First, details of changing the connection destination of the first candidate terminal are described. When the first candidate terminal is the first type terminal, the connection destination controller 17 changes the connection destination of the first candidate terminal to the other cell by releasing the radio resource of the exceeded cell allocated to the first candidate terminal. Specifically, the connection destination controller 17 releases the radio resource of the exceeded cell allocated to the first candidate terminal by causing the scheduler 12 to delete a radio resource ID corresponding to the first candidate terminal in the exceeded cell being the Scell. Further, the connection destination controller 17 instructs the first candidate terminal to stop use of the Scell.

When the first candidate terminal is the second type terminal, the connection destination controller 17 changes the connection destination of the first candidate terminal to the other cell by instructing the first candidate terminal to perform a handover from the exceeded cell to the other cell. Specifically, the connection destination controller 17 changes the connection destination of the first candidate terminal to the other cell by outputting, to the HO controller 18, a handover instruction which instructs the first candidate terminal to perform a handover of the exceeded cell to the other cell. Note that the handover between cells under control of the same base station device like the handover from the exceeded cell to the other cell is also called an Intra-eNB handover.

When the first candidate terminal is the third type terminal, the connection destination controller 17 performs the following processing. That is, the connection destination controller 17 releases the radio resource of the other cell allocated to the first candidate terminal and changes over the radio resource of the exceeded cell allocated to the first candidate terminal to the radio resource of the other cell, and thereby changes the connection destination of the first candidate terminal to the other cell. Specifically, the connection destination controller 17 causes the scheduler 12 to delete the radio resource ID corresponding to the first candidate terminal in the other cell being the Scell and thereby releases the radio resource of the other cell allocated to the first candidate terminal. Then, the connection destination controller 17 replaces the radio resource ID corresponding to the first candidate terminal in the exceeded cell being the Pcell with a free radio resource ID in the other cell and thereby changes the radio resource of the exceeded cell allocated to the first candidate terminal to the radio resource of the other cell. At that time, random access processing is performed between the base station device 1 and the first candidate terminal.

The connection destination controller 17 changes the connection destination of the first candidate terminal to the other cell in the order of the first type terminal, the second type terminal and the third type terminal. Amount of the processing for changing the connection destination of the first candidate terminal to the other cell becomes larger in the order of the first type terminal, the second type terminal and the third type terminal. For this reason, the connection destination controller 17 changes the connection destination of the first candidate terminal to the other cell in the order of the first type terminal, the second type terminal and the third type terminal, which is the ascending order of the processing amount.

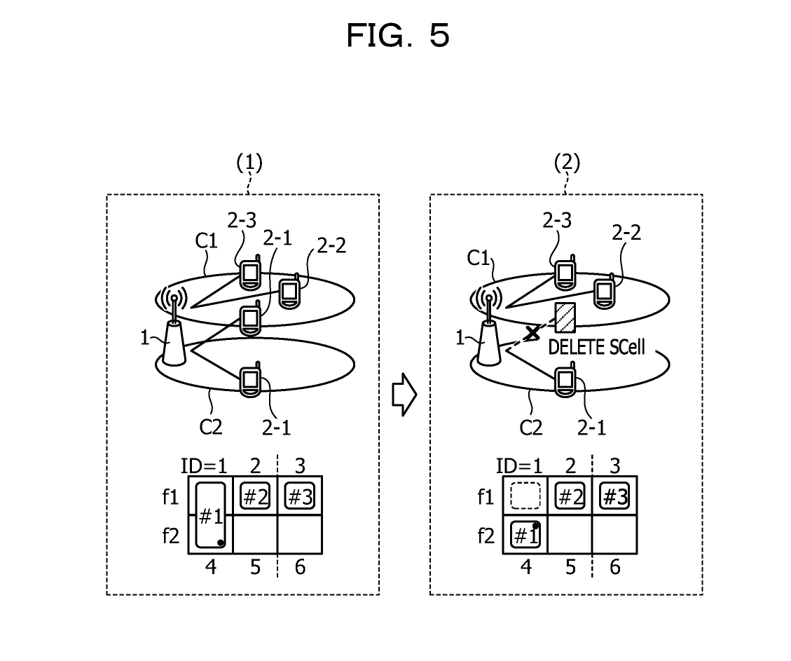

FIG. 5 is a diagram for illustrating an example of changing the connection destination of the first candidate terminal when the first candidate terminal is the first type terminal. In FIG. 5, assume that the base station device 1 may communicate with up to two terminals in each of the cells C1 and C2. That is, the connection number threshold indicating the number of the terminals connectable to each of the cells C1 and C2 is “2”. Additionally, in FIG. 5, f1 indicates the frequency band corresponding to the cell C1, and f2 indicates the frequency band corresponding to the cell C2. Moreover, in FIG. 5, ID is the radio resource ID, and three radio resource IDs are defined for each of the cells. Further, in FIG. 5, each of #1 to #3 indicates the radio resource allocated to the terminals 2-1 to 2-3 in each of the cells. Furthermore, in FIG. 5, assume that the terminal 2-1 is the terminal having the CA capability, and the terminals 2-2 and 2-3 are the terminals having the single band capability.

State (1) of FIG. 5 indicates a state in which the terminal 2-3 is newly connected to the cell C1 when the terminal 2-1 is simultaneously connected to the cell C2 being the Pcell, and the C1 being the Scell, and the terminal 2-2 is connected to the cell C1. Since the number of the terminals connected to the cell C1 exceeds the connection number threshold “2”, the candidate terminal selection unit 16 of the base station device 1 selects the first candidate terminal to be released from the connection to the cell C1 out of the terminals 2-1, 2-2, and 2-3 connected to the cell C1 which is the exceeded cell. The terminal 2-1 corresponds to the first type terminal since the terminal 2-1 is being simultaneously connected to the cell C2 being the Pcell and the cell C1 being the Scell, and communicating by using the radio resources of the Pcell and the Scell. Thus, the candidate terminal selection unit 16 selects the terminal 2-1 being the first type terminal as the first candidate terminal.

Then, as illustrated in state (2) of FIG. 5, the base station device 1 changes the connection destination of the terminal 2-1 by releasing the radio resource of the cell C1 allocated to the terminal 2-1 which is the first candidate terminal. Specifically, the connection destination controller 17 of the base station device 1 causes the scheduler 12 to delete the radio resource ID “1” corresponding to the terminal 2-1 in the cell C1 being the Scell and thereby releases the radio resource of the cell C1 allocated to the terminal 2-1. Thus, the number of the terminals connected to the cell C1 becomes not larger than the connection number threshold “2”, and thereby the connection between the terminal 2-3 and the base station device 1 is maintained.

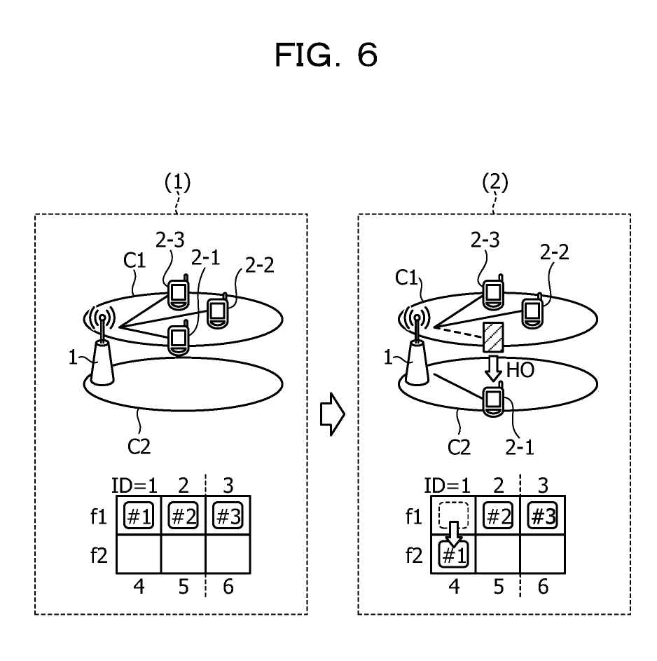

FIG. 6 is a diagram for illustrating an example of changing the connection destination of the first candidate terminal when the first candidate terminal is the second type terminal. In FIG. 6, assume that the base station device 1 may communicate with up to two terminals in each of the cells C1 and C2. That is, the connection number threshold indicating the number of the terminals connectable to each of the cells C1 and C2 is “2”. Additionally, in FIG. 6, f1 indicates the frequency band corresponding to the cell C1, and f2 indicates the frequency band corresponding to the cell C2. Moreover, in FIG. 6, ID is the radio resource ID, and three radio resource IDs are defined for each of the cells. Further, in FIG. 6, each of #1 to #3 indicates the radio resource allocated respectively to the terminals 2-1 to 2-3 in each of the cells. Furthermore, in FIG. 6, assume that the terminal 2-1 is the terminal having the multiband capability, and the terminals 2-2 and 2-3 are the terminals having the single band capability.

State (1) of FIG. 6 indicates a state in which the terminal 2-3 is newly connected to the cell C1 when the terminals 2-1 and 2-2 are connected to the cell C1. Since the number of the terminals connected to the cell C1 exceeds the connection number threshold “2”, the candidate terminal selection unit 16 of the base station device 1 selects the first candidate terminal to be released from the connection to the cell C1 out of the terminals 2-1, 2-2, and 2-3 connected to the cell C1 which is the exceeded cell. The terminal 2-1 corresponds to the second type terminal since the terminal 2-1 includes the multiband capability and whose reception power in the cell C2 is not smaller than a predetermined value. Thus, the candidate terminal selection unit 16 selects the terminal 2-1 being the second type terminal as the first candidate terminal.

Then, as illustrated in state (2) of FIG. 6, the base station device 1 changes the connection destination of the terminal 2-1 to the cell C2 by instructing the terminal 2-1 being the first candidate terminal to perform a handover from the cell C1 to the cell C2. Specifically, the connection destination controller 17 of the base station device 1 changes the connection destination of the terminal 2-1 to the cell C2 by outputting, to the HO controller 18, a handover instruction which instructs the terminal 2-1 to perform the handover from the cell C1 to the cell C2. When the terminal 2-1 performs the handover from the cell C1 to the cell C2, the scheduler 12 deletes the radio resource ID “1” corresponding to the terminal 2-1 in the cell C1 and newly allocates the radio resource ID “4” to the terminal 2-1 in the cell C2. Thus, the number of the terminals connected to the cell C1 becomes not larger than the connection number threshold “2”, and thereby the connection between the terminal 2-3 and the base station device 1 is maintained.

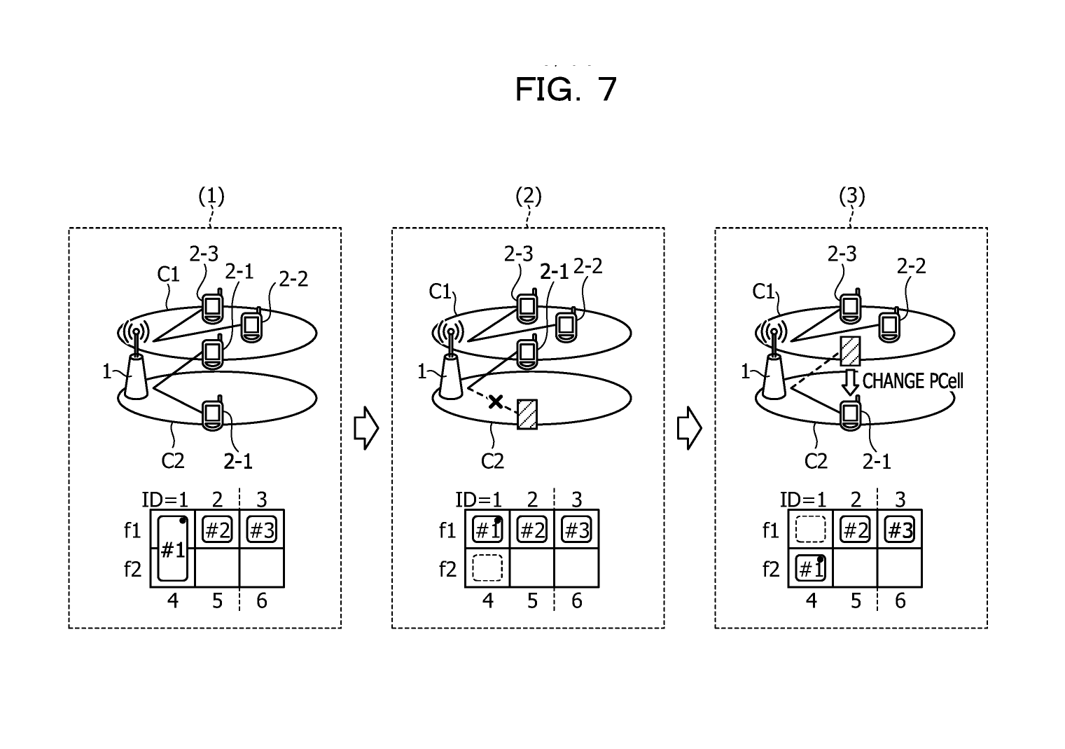

FIG. 7 is a diagram for illustrating an example of changing the connection destination of the first candidate terminal when the first candidate terminal is the third type terminal. In FIG. 7, assume that the base station device 1 may communicate with up to two terminals in each of the cells C1 and C2. That is, the connection number threshold indicating the number of the terminals connectable to each of the cells C1 and C2 is “2”. Additionally, in FIG. 7, f1 indicates the frequency band corresponding to the cell C1, and f2 indicates the frequency band corresponding to the cell C2. Moreover, in FIG. 7, ID is the radio resource ID, and three radio resource IDs are defined for each of the cells. Further, in FIG. 7, each of #1 to #3 indicates the radio resource allocated respectively to the terminals 2-1 to 2-3 in each of the cells. Furthermore, in FIG. 7, assume that the terminal 2-1 is the terminal having the CA capability, and the terminals 2-2 and 2-3 are the terminals having the single band capability.

State (1) of FIG. 7 indicates a state in which the terminal 2-3 is newly connected to the cell C1 when the terminal 2-1 is simultaneously connected to the cell C1 being the Pcell, and the C2 being the Scell, and the terminal 2-2 is connected to the cell C1. Since the number of the terminals connected to the cell C1 exceeds the connection number threshold “2”, the candidate terminal selection unit 16 of the base station device 1 selects the first candidate terminal to be released from the connection to the cell C1 out of the terminals 2-1, 2-2, and 2-3 connected to the cell C1 which is the exceeded cell. The terminal 2-1 corresponds to the third type terminal since the terminal 2-1 is being simultaneously connected to the cell C1 being the Pcell and the cell C2 being the Scell and communicating by using the radio resources of the Pcell and the Scell. Thus, the candidate terminal selection unit 16 selects the terminal 2-1 being the third type terminal as the first candidate terminal.

Then, as illustrated in state (2) of FIG. 7, the base station device 1 releases the radio resource of the cell C2 allocated to the terminal 2-1 which is the first candidate terminal. Specifically, the connection destination controller 17 of the base station device 1 causes the scheduler 12 to delete the radio resource ID “4” corresponding to the terminal 2-1 in the cell C2 being the Scell and thereby releases the radio resource of the cell C2 allocated to the terminal 2-1.

Then, as illustrated in state (3) of FIG. 7, the base station device 1 changes the connection destination of the terminal 2-1 to the cell C2 by changing over the radio resource of the cell C1 allocated to the terminal 2-1 being the first candidate terminal to the radio resource of the cell C2. Specifically, the connection destination controller 17 of the base station device 1 causes the scheduler 12 to replace the radio resource ID “1” corresponding to the terminal 2-1 in the cell C1 being the Pcell with the radio resource ID “4” released in the cell C2. Thus, the number of the terminals connected to the cell C1 becomes not larger than the connection number threshold “2”, and thereby the connection between the terminal 2-3 and the base station device 1 is maintained.

Next, details of changing the connection destination of the second candidate terminal are described. The connection destination controller 17 receives input of the transmission power reduction amount from the candidate terminal selection unit 16. The connection destination controller 17 instructs the transmission power controller 20 to reduce the transmission power of a cell to which the second candidate terminal is connected, by the transmission power reduction amount, and when the transmission power is reduced, changes the connection destination of the second candidate terminal to the adjacent cell. Specifically, the connection destination controller 17 changes the connection destination of the second candidate terminal to the adjacent cell by instructing the second candidate terminal to perform a handover from the exceeded cell or the other cell to the adjacent cell.

When changing the connection destination of the second candidate terminal selected out of the multiple terminals connected to the other cell to the adjacent cell, the connection destination controller 17 again performs the processing of changing the connection destination of the first candidate terminal to the other cell.

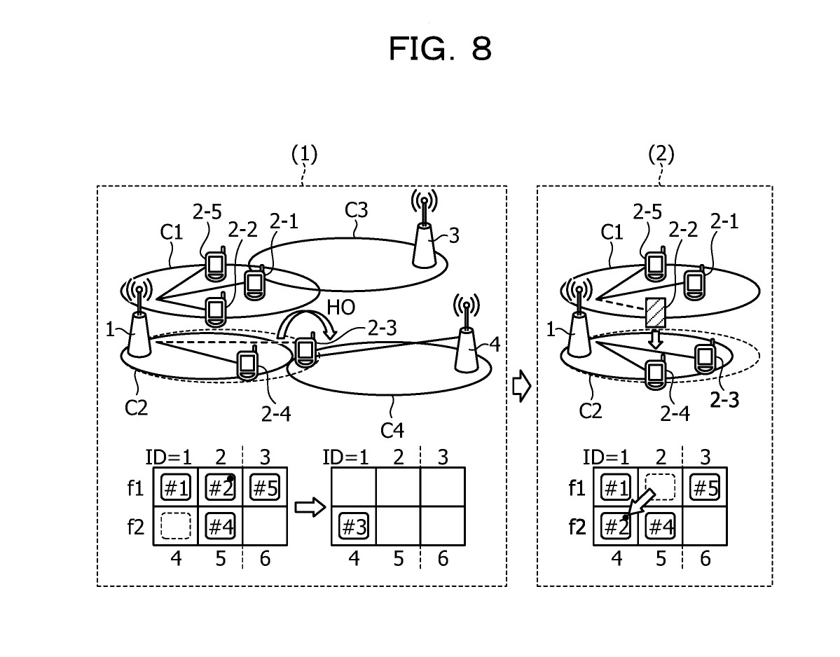

FIG. 8 is a diagram for illustrating an example of changing the connection destination of the second candidate terminal. In FIG. 8, assume that the base station device 1 may communicate with up to two terminals in each of the cells C1 and C2. That is, the connection number threshold indicating the number of the terminals connectable to each of the cells C1 and C2 is “2”. In FIG. 8, the other base station device 3 manages the cell C3 which is the adjacent cell located adjacent to the cell C1, and another base station device 4 manages the cell C4 which is the adjacent cell located adjacent to the cell C2. Additionally, in FIG. 8, f1 indicates the frequency band common to the cells C1 and C3, and f2 indicates the frequency band common to the cells C2 and C4. Moreover, in FIG. 8, ID is the radio resource ID, and three radio resource IDs are defined for each of the cells. Further, in FIG. 8, each of #1 to #5 indicates the radio resource allocated to the terminals 2-1 to 2-5 in each of the cells. Furthermore, in FIG. 8, assume that the terminal 2-2 is the terminal having the CA capability, and the terminal 2-1 and the terminals 2-3 to 2-5 are the terminals having the single band capability.

State (1) of FIG. 8 indicates a state in which the terminal 2-5 is newly connected to the cell C1 being the Pcell when the terminal 2-2 is connected to the cell C1, the terminal 2-1 is connected to the cell C1, and the terminals 2-3 and 2-4 are connected to the C2. In state (1) of FIG. 8, the number of the terminals connected to the cell C1 exceeds the connection number threshold “2”. Thus, the candidate terminal selection unit 16 of the base station device 1 selects the second candidate terminal to be released from the connection to the cell C1 or C2 out of the multiple terminals connected to the cell C1 which is the exceeded cell or out of the multiple terminals connected to the other cell.

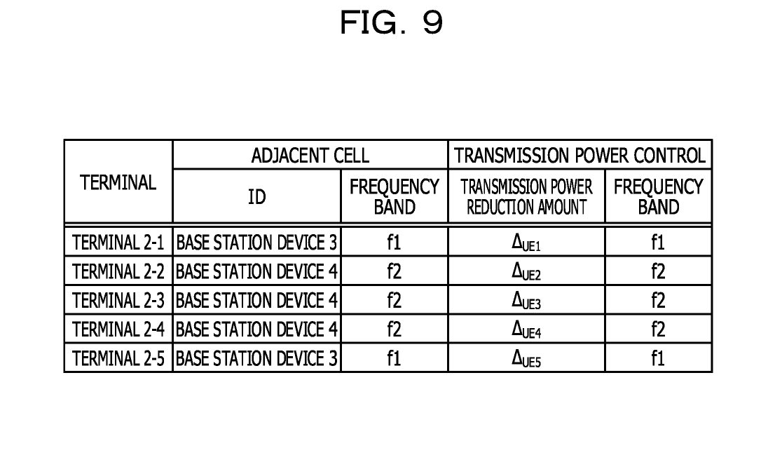

The candidate terminal selection unit 16 calculates a transmission power reduction amount Δ such that an amount of the transmission power is more reduced as the adjacent cell reception quality becomes lower, of each of the multiple terminals connected to the cell C1 which is the exceeded cell and of each of the multiple terminals connected to the cell C2 which is the other cell. The candidate terminal selection unit 16 stores the calculated transmission power reduction amount Δ into an internal table by associating with each of the multiple terminals connected to the cell C1 which is the exceeded cell and each of the multiple terminals connected to the cell C2 which is the other cell. FIG. 9 illustrates an example of the internal table used by the candidate terminal selection unit 16.

With reference to the inner table, the candidate terminal selection unit 16 selects a terminal having the lowest transmission power reduction amount Δ as the second candidate terminal out of the multiple terminals connected to the cell C1 which is the exceeded cell and out of the multiple terminals connected to the cell C2 which is the other cell. In the example illustrated in FIG. 9, the terminal 2-3 is a terminal having the highest adjacent cell reception quality with respect to the adjacent cell C4 and the transmission power reduction amount Δ_{UE3} corresponding to the terminal 2-3 is the lowest. Thus, the candidate terminal selection unit 16 selects the terminal 2-3 as the second candidate terminal.

Then, as illustrated in state (1) of FIG. 8, the base station device 1 reduces the transmission power of the cell C2 to which the terminal 2-3 being the second candidate terminal is connected by the transmission power reduction amount Δ, and when the transmission power is reduced, changes the connection destination of the terminal 2-3 to the cell C4 which is the adjacent cell. Specifically, the connection destination controller 17 of the base station device 1 instructs the transmission power controller 20 to reduce the transmission power of the cell C2 to which the terminal 2-3 is connected by the transmission power reduction amount Δ. Then, the connection destination controller 17 changes the connection destination of the terminal 2-3 to the cell C4 by outputting, to the HO controller 18, the handover instruction which instructs the terminal 2-3 to perform a handover from the cell C2 to the cell C4. When the terminal 2-3 performs the handover from the cell C2 to the cell C4, the scheduler 12 of the base station device 1 deletes the radio resource ID “4” in the cell C2. In the example of FIG. 8, the connection destination controller 17 changes the connection destination of the terminal 2-3 selected out of the multiple terminals connected to the cell C2 which is the other cell, not out of the multiple terminals connected to the cell C1 which is the exceeded cell, to the cell C4 which is the adjacent cell. Therefore, the number of the terminals connected to the cell C1 which is the exceeded cell still exceeds the connection number threshold “2”.

When changing the connection destination of the terminal 2-3 selected out of the multiple terminals connected to the cell C2 to the cell C4 which is the adjacent cell, the base station device 1 again performs the processing of changing the connection destination of the first candidate terminal to the other cell as illustrated in state (2) of FIG. 8. Specifically, the candidate terminal selection unit 16 of the base station device 1 selects the first candidate terminal to be released from the connection to the cell C1 out of terminals 2-1, 2-2, and 2-5 connected to the cell C1 which is the exceeded cell. Here, the terminal 2-2 corresponds to a kind of the third type terminal which has CA capability and is connected only to the cell C1 being the Pcell and communicating by using the radio resources of the Pcell. Thus, the candidate terminal selection unit 16 selects the terminal 2-2 as the first candidate terminal. Then, the connection destination controller 17 of the base station device 1 causes the scheduler 12 to replace the radio resource ID “2” corresponding to the terminal 2-2 in the cell C1 which is the Pcell with the radio resource ID “4” released in the cell C2. That is, the Pcell of the terminal 2-2 is changed from the cell C1 to the cell C2. Thus, the number of the terminals connected to the cell C1 becomes not larger than the connection number threshold “2”, and thereby the connection between the terminal 2-5 and the base station device 1 is maintained.

Description is continued by referring back to FIG. 3. The HO controller 18 performs the predetermined processing of handover with the radio communication unit 11 in accordance with the instruction from the connection destination controller 17.

The reception quality collection unit 19 collects adjacent cell reception quality from the terminals connected to each of the multiple cells managed by the radio communication unit 11. The reception quality collection unit 19 outputs the collected adjacent cell reception quality to the candidate terminal selection unit 16.

The transmission power controller 20 controls, for each of the cells, transmission power which is managed in the radio communication unit 11. For example, the transmission power controller 20 controls the radio communication unit 11 in accordance with the instruction from the connection destination controller 17 and thereby reduces the transmission power of the cell to which the second candidate terminal is connected, by the transmission power reduction amount.

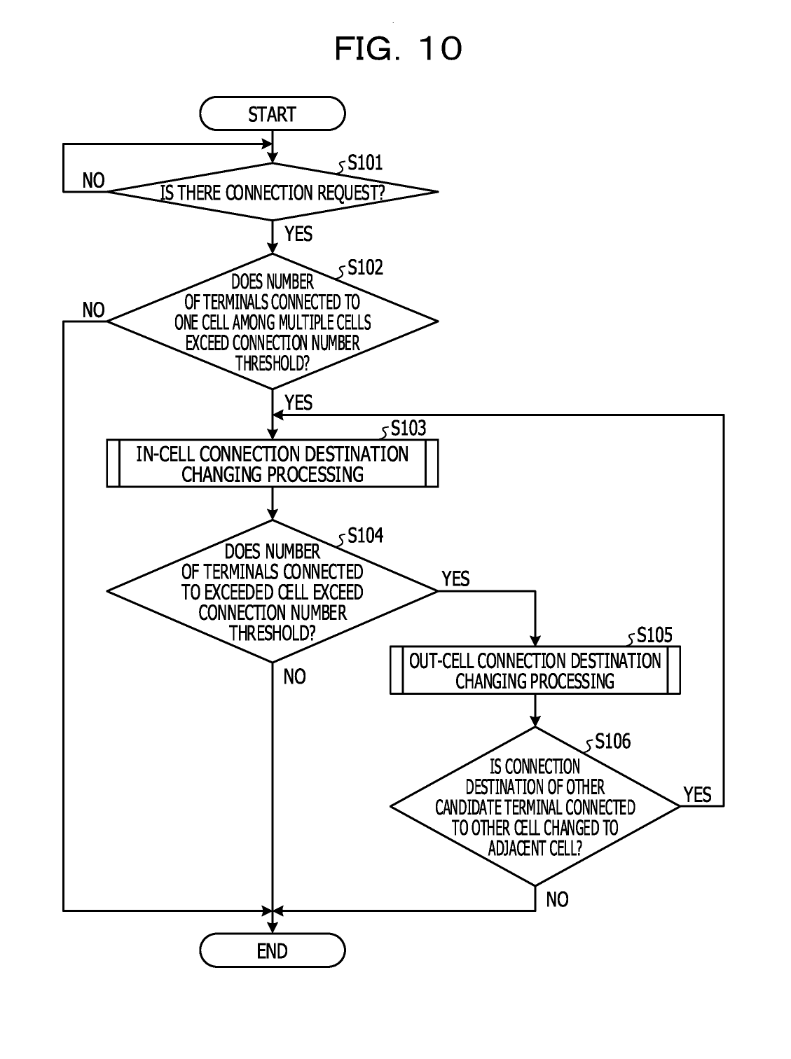

Next, an example of a process flow of changing the connection destination of the terminal by the base station device according to the embodiment is described with reference to FIG. 10. FIG. 10 is a flowchart of a process of changing the connection destination of the terminal by the base station device according to the embodiment.

As illustrated in FIG. 10, the base station device 1 waits if there is no connection request (No in step S101). Meanwhile, when there is a connection request (Yes in step S101), the base station device 1 detects whether the number of the multiple terminals connected to one cell among the multiple cells managed by the radio communication unit 11 exceeds the connection number threshold (step S102). If the number of the multiple terminals connected to one cell among the multiple cells is not larger than the connection number threshold (No in step S102), the base station device 1 ends the processing.

Meanwhile, if the number of the multiple terminals connected to one cell among the multiple cells exceeds the connection number threshold (Yes in step S102), the base station device 1 performs an in-cell connection destination changing processing (step S103). The in-cell connection destination changing processing is a processing of selecting the first candidate terminal being the terminal to be released from the connection to the exceeded cell out of the multiple terminals connected to the exceeded cell, and changing the connection destination of the first candidate terminal to the other cell. Details of the in-cell connection destination changing processing are described later. After performing the in-cell connection destination changing processing, if the number of the multiple terminals connected to the exceeded cell is not larger than the connection number threshold (No in step S104), the base station device 1 ends the processing.

If the number of the multiple terminals connected to the exceeded cell exceeds the connection number threshold (Yes in step S104), the base station device 1 performs an out-cell connection destination changing processing (step S105). The out-cell connection destination changing processing is a processing of selecting the second candidate terminal being the terminal to be released from the connection to the exceeded cell or the other cell among the multiple terminals connected to the exceeded cell and the multiple terminals connected to the other cell, and changing the connection destination of the second candidate terminal to the adjacent cell. Details of the out-cell connection destination changing processing are described later.

In the out-cell connection destination changing processing, when the connection destination of the second candidate terminal selected out of the multiple terminals connected to the other cell is changed to the adjacent cell (Yes in step S106), the base station device 1 returns the processing to the step S103 and again performs the in-cell connection destination changing processing.

Meanwhile, in the out-cell connection destination changing processing, when the connection destination of the second candidate terminal selected out of the multiple terminals connected to the exceeded cell is changed to the adjacent cell (No in step S106), the base station device 1 ends the processing.

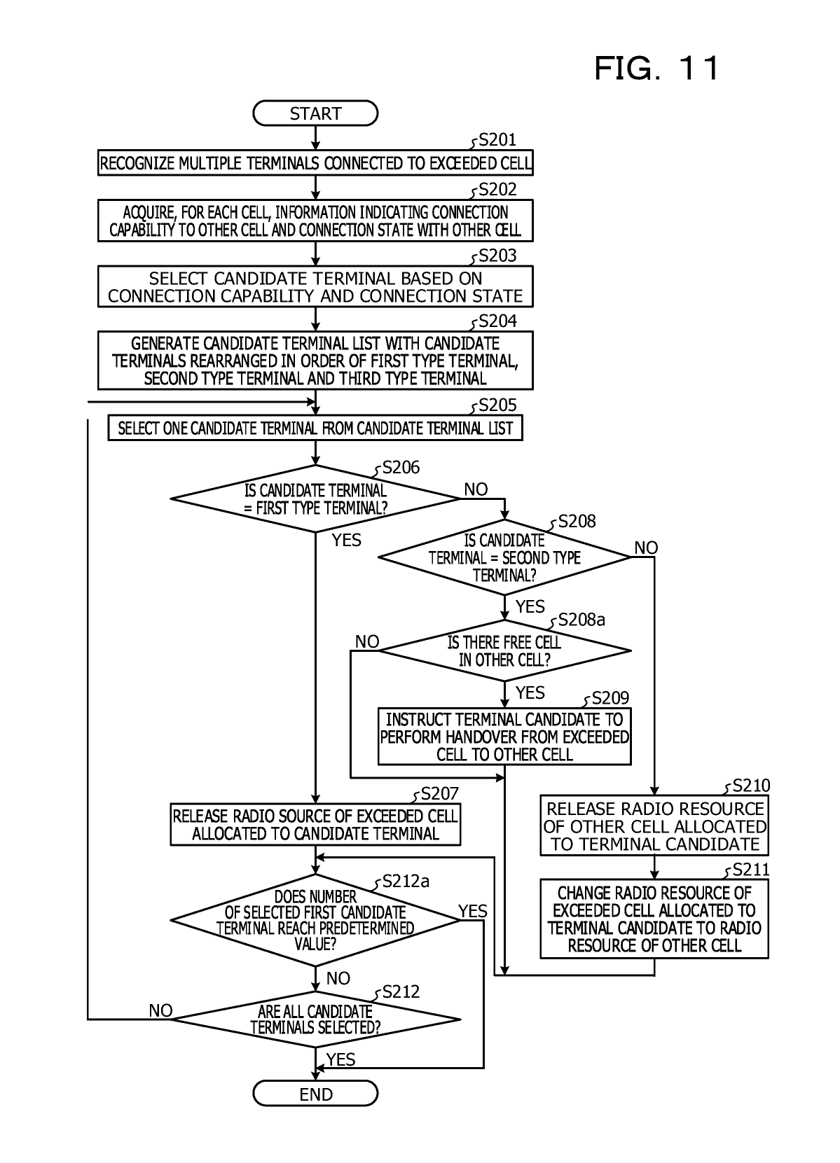

Next, an example of a flow of the in-cell connection destination changing processing according to the embodiment is described with reference to FIG. 11. FIG. 11 is a flowchart of the in-cell connection destination changing processing according to the embodiment. The in-cell connection destination changing processing illustrated in FIG. 11 corresponds to the step S103 illustrated in FIG. 10.

As illustrated in FIG. 11, the terminal information management unit 15 of the base station device 1 recognizes the multiple terminals connected to the exceeded cell (step S201) and acquires, for each of the terminals, terminal information indicating the connection capability to the other cell and the connection state with the other cell (step S202).

Based on the connection capability and the connection state indicated in the terminal information, the candidate terminal selection unit 16 selects the first candidate terminal out of the multiple terminals connected to the exceeded cell (step S203). The first candidate terminal is the first type terminal, the second type terminal or the third type terminal.

The connection destination controller 17 generates the candidate terminal list with the first candidate terminals rearranged in the order of the first type terminal, the second type terminal and the third type terminal (step S204).

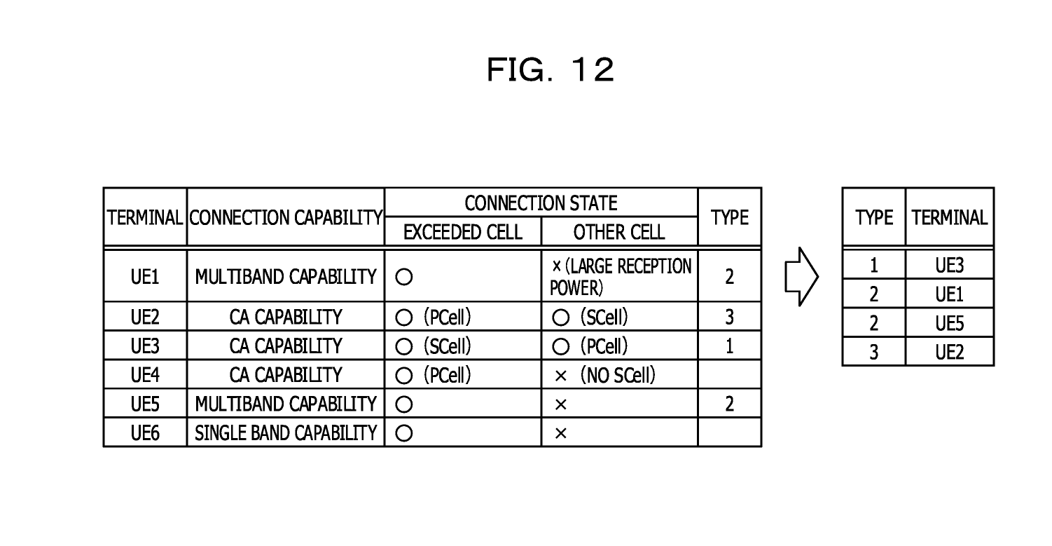

FIG. 12 is a diagram for illustrating an example of generating the candidate terminal list. On the left side of FIG. 12, assume that out of the multiple terminals (UE1 to UE6) connected to the exceeded cell, the terminals UE1, UE2, UE3 and UE5 are selected as the first candidate terminal based on the connection capability and the connection state. The terminal UE1 is the second type terminal. The terminal UE2 is the third type terminal. The terminal UE3 is the first type terminal. The terminal UE5 is the second type terminal and has a lower reception power in the other cell than the terminal UE1 of the same type. In such a case, as illustrated on the right side of FIG. 12, the connection destination controller 17 generates the candidate terminal list by rearranging the candidate terminals UE1, UE2, UE3, and UE5 in the order of the first type terminal, the second type terminal and the third type terminal.

Description is continued by referring back to FIG. 11. The connection destination controller 17 selects one first terminal candidate from the candidate terminal list in the order of the first type terminal, the second type terminal and the third type terminal (step S205).

When the selected first candidate terminal is the first type terminal (Yes in step S206), the connection destination controller 17 changes the connection destination of the first candidate terminal to the other cell by releasing the radio resource of the exceeded cell allocated to the first candidate terminal (step S207).

When the selected first candidate terminal is the second type terminal (No in step S206 and Yes in step S208), the connection destination controller 17 determines whether there is a free ID in the other cell (step S208a). When there is the free ID in the other cell (Yes in step S208a), the connection destination controller 17 changes the connection destination of the first candidate terminal to the other cell by instructing the first candidate terminal to perform the handover from the exceeded cell to the other cell (step S209). Meanwhile, when there is no free IDs in the other cell (No in step S208a), the connection destination controller 17 shifts the processing to the step S212a.

When the selected first candidate terminal is the third type terminal (No in step S208), the connection destination controller 17 performs the following processing. That is, the connection destination controller 17 releases the radio resource of the other cell allocated to the first candidate terminal (step S210) and changes over the radio resource of the exceeded cell allocated to the first candidate terminal to the radio resource of the other cell (step S211). Thus, the connection destination controller 17 changes the connection destination of the first candidate terminal to the other cell.

Then, the connection destination controller 17 determines whether the number of selected first candidate terminals has reached a predetermined number (step S212a). When the number of selected first candidate terminals reaches the predetermined number (Yes in step S212a), the connection destination controller 17 ends the processing.

Meanwhile, if the number of selected first candidate terminals does not reach the predetermined number (No in step S212a), the connection destination controller 17 shifts the processing to the step S212.

If all first candidate terminals are not selected from the candidate terminal list (No in step S212), the connection destination controller 17 returns the processing to the step S205. If all first candidate terminals are selected from the candidate terminal list (Yes in step S212), the connection destination controller 17 ends the processing. That is, the connection destination controller 17 repeats the processing of steps S205 to S212 and thereby changes the connection destination of the first candidate terminal to the other cell in the order of the first type terminal, the second type terminal and the third type terminal with reference to the candidate terminal list.

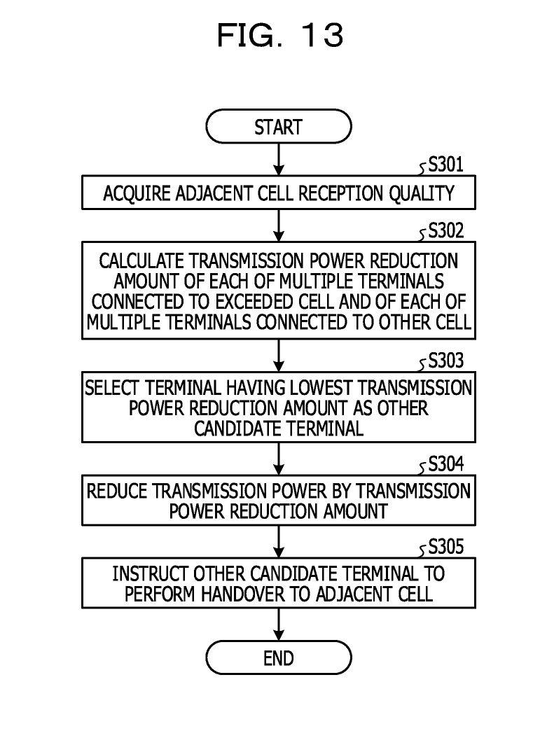

Next, an example of a flow of the out-cell connection destination changing processing according to the embodiment is described with reference to FIG. 13. FIG. 13 is a flowchart of the out-cell connection destination changing processing according to the embodiment. The out-cell connection destination changing processing illustrated in FIG. 13 corresponds to the step S105 illustrated in FIG. 10.

As illustrated in FIG. 13, the reception quality collection unit 19 of the base station device 1 collects the adjacent cell reception quality from the terminals connected to each of the multiple cells managed by the radio communication unit 11 (step S301).

The candidate terminal selection unit 16 calculates the transmission power reduction amount such that an amount of the transmission power used for communication of the radio communication unit 11 is more reduced as the adjacent cell reception quality becomes lower, of each of the multiple terminals connected to the exceeded cell and of each of the multiple terminals connected to the other cell (step S302).

The candidate terminal selection unit 16 selects, out of the multiple terminals connected to the exceeded cell and the multiple terminals connected to the other cell, a terminal having the lowest transmission power reduction amount as the second candidate terminal (step S303).

The connection destination controller 17 instructs the transmission power controller 20 to reduce the transmission power of the cell to which the second candidate terminal is connected, by the transmission power reduction amount (step S304).

The connection destination controller 17 changes the connection destination of the second candidate terminal to the adjacent cell by instructing the second candidate terminal to perform the handover from the exceeded cell or other cell to the adjacent cell (step S305).

As described above, when the number of terminals connected to one cell exceeds the connection number threshold, the base station device 1 according to the embodiment selects the first candidate terminal based on the connection capability to the other cell excluding the exceeded cell, and based on the connection state to the other cell, and changes the connection destination of the selected first candidate terminal to the other cell. Thus, according to the embodiment, the number of the terminals may be reduced by using the other cell managed by the base station device 1 in the exceeded cell in which the number of the terminals exceeds the connection number threshold, without performing the handover to the adjacent cell being a cell of the other base station device and reducing the transmission power. As a result, according to the embodiment, deterioration of the signal quality in each of the multiple cells managed by the base station device 1 may be suppressed.

If the number of the terminals still exceeds the connection number threshold after the connection destination of the first candidate terminal is changed to the other cell, the base station device 1 selects the second candidate terminal out of the terminals connected to the exceeded cell and out of the terminals connected to the other cell, and changes the connection destination of the selected second candidate terminal to the adjacent cell. As a result, according to the embodiment, the number of the terminals may be reduced by using the adjacent cell of the other base station device adjacent to a cell managed by the base station device 1, and deterioration of the signal quantity in the cell with respect to a terminal staying in the cell managed by the base station device 1 may be reduced.

(Hardware Configuration)

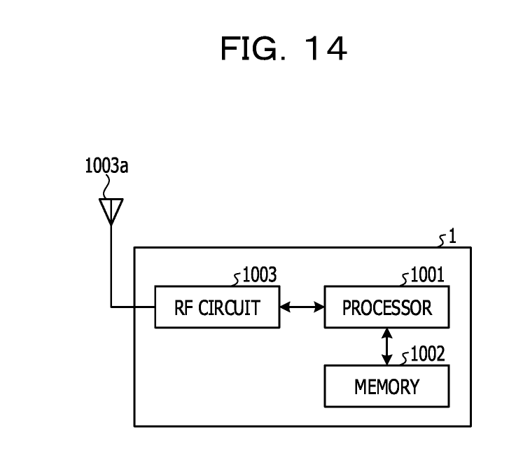

The base station device 1 of the above embodiment may be implemented, for example, by such a hardware configuration as illustrated in FIG. 14. FIG. 14 illustrates a hardware configuration example of the base station device.

As illustrated in FIG. 14, the base station device 1 includes, as hardware components, a processor 1001, a memory 1002, and a radio frequency (RF) circuit 1003. The RF circuit 1003 includes an antenna 1003a. The memory 1002 comprises, for example, a random access memory (RAM), a read only memory (ROM), and a flash memory. The radio communication unit 11 illustrated in FIG. 3 is implemented, for example, by an analog circuit such as the RF circuit 1003. The scheduler 12, the call connection unit 13, the connection number determination unit 14, the terminal information management unit 15, the candidate terminal selection unit 16, the connection destination controller 17, the HO controller 18, the reception quality collection unit 19 and the transmission power controller 20 are implemented by an integrated circuit such as, for example, the processor 1001.

Various processings described in the above embodiment may be implemented when programs prepared in advance are executed by a computer. Programs corresponding to processings performed by the scheduler 12, the call connection unit 13, the connection number determination unit 14, the terminal information management unit 15, the candidate terminal selection unit 16, the connection destination controller 17, the HO controller 18, the reception quality collection unit 19 and the transmission power controller 20 are stored in the memory 1002. Then, each program functions as a process when read by the processor 1001.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a memory; and
a processor coupled to the memory and configured to:
form a plurality of cells, each of the plurality of cells having each of a plurality of different frequency bands,
obtain capability information and state information when a number of a plurality of terminals coupling to a specified cell of the plurality of cells exceeds a predetermined threshold, the capability information indicating each capability of each of the plurality of terminals for coupling to a different cell of the plurality of cells, the state information indicating each state of each coupling between each of the plurality of terminals and the different cell,
select a first terminal from among the plurality of terminals based on the first information and the second information, a coupling between the first terminal and the specified cell being to be released, and
switch a cell coupled by the first terminal, from the specified cell to the different cell.

2. The base station according to claim 1, wherein
a terminal of the plurality of terminals, when the terminal has an capability for coupling to the different cell and a state of coupling between the terminal and the different cell is better than a predetermined state, is selected to be the first terminal.

3. The base station according to claim 1, wherein
a terminal of the plurality of terminals, when the terminal does not have an capability for coupling to the different cell, is not selected to be the first terminal.

4. The base station according to claim 1, wherein
a terminal of the plurality of terminals, when a state of coupling between the terminal and the different cell is not better than a predetermined state, is not selected to be the first terminal.

5. The base station according to claim 1, wherein
the first terminal is one of a terminal of first type and a terminal of second type and a terminal of third type, the terminal of first type being a terminal that communicates with the different cell and the specified cell depending on the different cell in parallel, the terminal of second type being a terminal that communicates with one of the different cell and the specified cell, the terminal of third type being a terminal that communicates with the specified cell and the different cell depending on the specified cell in parallel.

6. The base station according to claim 1, wherein
when the first terminal is the terminal of first type, the processor is configured to release a radio resource for the first terminal for coupling to the different cell.

7. The base station according to claim 1, wherein
when the first terminal is the terminal of second type, the processor is configured to command the first terminal to perform handover from the specified cell to the different cell.

8. The base station according to claim 1, wherein
when the first terminal is the terminal of third type, the processor is configured to release a radio resource for the first terminal for coupling to the different cell and to switch a radio resource, for the first terminal for coupling to the specified cell, to the different cell.

9. The base station according to claim 1, wherein
the cell coupled by the first terminal is switched form the specified cell to the different cell in order of the first type of terminal, the second type of terminal and the third type of terminal.

10. The base station according to claim 1, wherein
the processor is further configured to:
obtain third information indicating each received quality of each of the plurality of terminals from another cell formed by another base station,
select, after a cell coupled by the first terminal is switched from the specified cell to the different cell and when the number of plurality of terminals coupling to the specified cell exceeds the predetermined threshold, a second terminal from among the plurality of terminals coupling to the specified cell and a plurality of different terminals coupling to the different cell based on the third information, a coupling between the second terminal and the specified cell or the different cell being to be released, and
switch a cell coupled by the second terminal to the another cell.

11. A method for controlling a wireless communication, the method comprising:
forming a plurality of cells, each of the plurality of cells having each of a plurality of different frequency bands;
obtaining capability information and state information when a number of a plurality of terminals coupling to a specified cell of the plurality of cells exceeds a predetermined threshold, the capability information indicating each capability of each of the plurality of terminals for coupling to a different cell of the plurality of cells, the state information indicating each state of each coupling between each of the plurality of terminals and the different cell;
selecting a first terminal from among the plurality of terminals based on the first information and the second information, a coupling between the first terminal and the specified cell being to be released; and
switching a cell coupled by the first terminal, from the specified cell to the different cell.
